(19) United States
(12) Patent Application Publication
(10) Pub. No.: US 2017/0198843 A1
(43) Pub. Date: Jul. 13, 2017

(54) Manual pipe valve connector for jointed pipe connections with quick release check valve assembly and uses thereof

(71) Applicant: Stuart McLaughlin, Magnolia, TX (US)

(72) Inventor: Stuart McLaughlin, Magnolia, TX (US)

(21) Appl. No.: 15/330,946

(22) Filed: Feb. 3, 2015

Related U.S. Application Data
(60) Provisional application No. 61/935,186, filed on Feb. 3, 2014.

(51) Int. Cl. F16L 19/00; E21B 17/043; F16L 19/02

(52) U.S. Cl. CPC F16L 19/005; F16L 19/02; E21B 17/043

(57) ABSTRACT

A connection that provides for a means to manually make-up a pipe connection or assembly without the need for wrenches, tongs, hydraulic torque equipment, etc. A connection design that can be assembled and manufactured without threads and permits the same loading, torque and integrity requirements of threaded joint systems. A system that incorporates a locking mechanism that requires only manual effort to disengage.

### CROSS-REFERENCE TO RELATED APPLICATION

This non-provisional application claims benefit of provisional application U.S. Ser. No. 61/935,186 filed on Feb. 3, 2014.

### BACKGROUND

Field of the invention

The present invention generally relates to the design of a mechanical connection assembly used in conjunction with jointed pipe., threaded pipe, coiled tubing, stick pipe and any threaded or non-threaded pipe section or tubular for down hole operations that involve and utilize in-line safety valves also known in the art as check valves, safety valves, flapper valves and ball valves or valves of similar nature that permit isolation of wellbore fluids from returning to surface via the tubular inside diameter. In particular aspects, the invention relates to a device used for connecting joints of pipe using a manual make up connection (Clutch) that requires no significant tools other than an Allen wrench or screw driver type hand tool to secure the connection. The system can also be used to make up a system known as a bottom hole assembly (BHA). A secondary aspect to the connection is the ability to prevent return of hydrocarbons or fluid and gas of any type to surface by use of a single or multi check valve arrangement integrated into the connection. This dual flapper cheek valve arrangement, depicted in the art work, provides for servicing of the flapper carrier assembly on the rig floor without the need to rig down surface equipment. The present invention also permits torque loading through the connector in both clockwise and anti clockwise direction without risk of backing off the assembly it is attached too.

The ability to eliminate threaded connections from many aspects of the oil and gas industry provides for superior joints in terms of a useable connection that cannot back off, eliminates specification requirements for makeup torque, prevents mistakes, vastly reduces the risk of accident and injury and reduces time and increase cost efficiencies across the operational spectrum, for example during drilling or coiled tubing deployed through tubing intervention or drilling

Description of the Related Art

Standard oil and gas practices use threaded pipe connection; a box thread on top of the pipe and a pin thread on the bottom. These threads permit connection to other pipe sections but also allows for connection to other assemblies and tools Is mown as a bottom hole assembly or BHA.

The current invention provides for a system that allows pipe, coil tubing, bottom hole assemblies and other devices, strings, components, tools and equipment to be connected using a is manual make up connection whereby no ‘iron roughneck’, tongs, wrenches or other significant mechanical, pneumatically or hydraulically actuated systems am needed to connect two pipe joints together.

Makeup of the pipe is achieved by pushing the connections together and rotating manually a threaded ring, that locks bob the male and female connections together making a joint suitable in strength and application to use in all environments currently used for jointed connections. Within the joint the cheek valve assembly, if needing servicing in the event the surface integrity test fails, can be manually retrieved from the connection and either serviced or replaced in-situ. Something current system do not offer.

### SUMMARY OF THE INVENTION

The present invention offers significant improvements over that of today's thread pipe and bottom hole assembly systems. Whereas premium threads are required to ensure pressure integrity of the pipe connection, bottom hole assembly or tooling the Clutch connector accomplishes this by use of elastomeric seals containing pressure both tubing and annular. Detrimental to today's connections is the need for heavy makeup equipment. This makeup equipment can come in many forms but ultimately provide the same end result—a tight high torque sealing connection. Makeup equipment to secure the threads requires heavy equipment such as iron rough neck systems. These systems are both expensive, heavy,hydraulically actuated and require skill and training to use w efficiently and safely. Other tools such as manual rig tongs have been known to be extremely dangerous with many incidents recorded over the decades and many men losing fingers and other body parts. Wrenches and come-a longs, chains have been and are still employed to make up smaller pipe and coiled tubing assemblies. These are also very dangerous techniques to implement and offer the end user little margin for safety when in use. Other ways to secure threaded connections include throwing chains, strap wrenches and even bonding agents. hi many of these applications the actual torque force required to secure the pipe thread connection is rzut recorded during thread makeup and as such equipment is prone to back off and ultimately left down hole to be retrieved ‘fished’ at a later date.

The present invention eliminates the need for all of the above aforementioned systems, provides for an exceptionally strong connection, increase safety to personnel masking up the connection and eliminates unknown torque requirements for the connection because there are no torque specifications needed.

Also today's pipe connections offer no pressure integrity within the pipe body to prevent hydrocarbons or fluids to return to surface either at a single joint point or at multiple joint intervals. Normally a surface Kelly valve or ball valve/BoP system is installed to aid in the control and prevention of hydrocarbons to surface. The present invention incorporates a dual flapper check valve carrier that is ‘on the pipe’ serviceable and can he employed at one or multiple joints. The flapper check can also he replaced with a ball valve system to eliminate the need for the Kelly valve. Threaded pipe connections have only one way to transmit torque through the string and that is in the direction of the thread machined profile, generally clockwise. This means that in the event of back torque, stick slip of pipe or indeed anti-clockwise rotation, the risk of backing off the threaded connection is highly possible and happens regularly throughout the industry. The present invention eliminates the possibility of thread back off due to the implementation of multi-castellation on both the male and female connections. In the event pipe problems occur, stuck pipe, sticking in hole, debris issues, etc the Clutch connector can be manipulated both in the clockwise and anti clockwise directions to aid in freeing the pipe. This cannot be achieved with todays threaded technology due to risk of thread back-off and separation of the tubing, drill pipe, bottom hole assembly.

The present invention allows for makeup and breakout of connections in seconds rather than minutes and provides for a safer handling pipe joint, bottom hole assembly or tooling accessories.

### BRIEF DESCRIPTION THE DRAWINGS

The advantages and other aspects of the invention will be readily appreciated by those of skill in the art and better understood with further reference to the accompanying drawings in which like reference characters designate like or similar elements throughout the several figures of the drawings and wherein:

FIG. 1 illustrates an exemplary wellbore 3 which has been drilled through the earth 4 down to a hydrocarbon-bearing formation 5 from the surface 6. Perforations 7, a type known in the art, extend through the wellbore 3 and outwardly into the formation 5 to permit hydrocarbon production fluid to flow from the formation 5 to the interior of the wellbore 3.

FIG. 2 is a cross sectional view of the fully assembled connector is the released position numerically detailed constructed in accordance with the present invention.

FIG. 3 is a cross sectional view of the fully assembled connector is the released position constructed in accordance with the present invention.

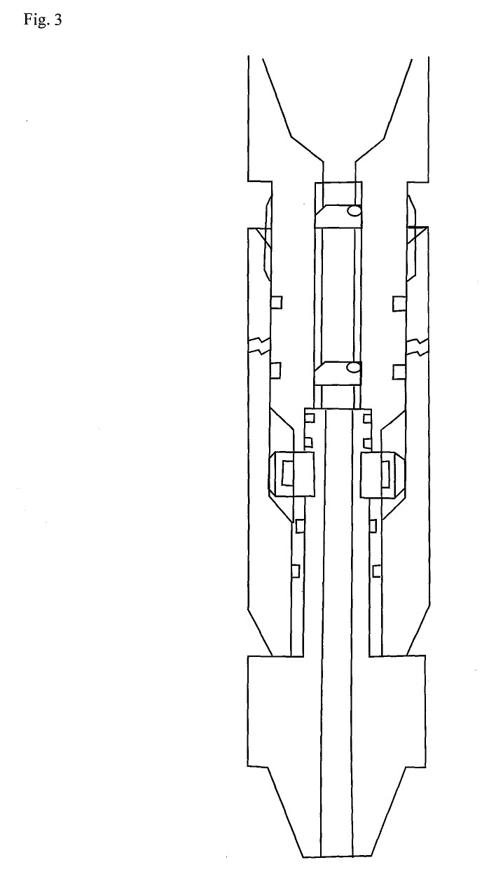

FIG. 4 is a cross sectional view of the fully assembled connector is the Locked position constructed in accordance with the present invention.

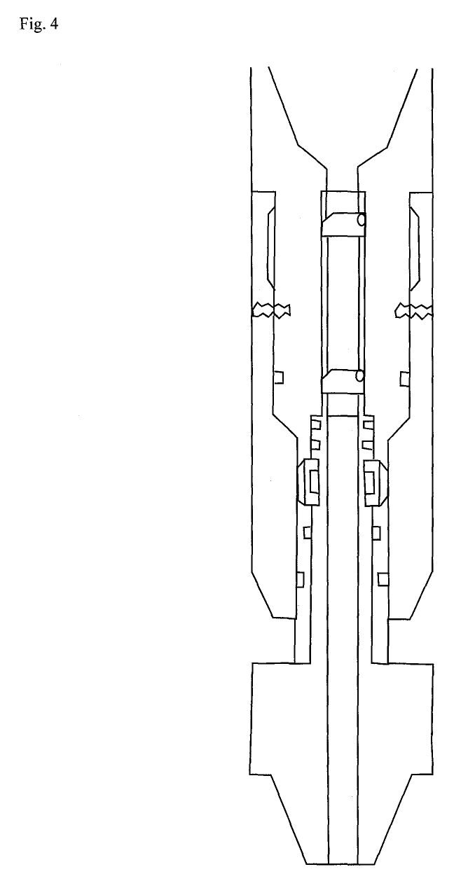

FIG. 5 is a cross sectional view of a pipe joint portraying the male and female connectors disconnected constructed in accordance with the present invention.

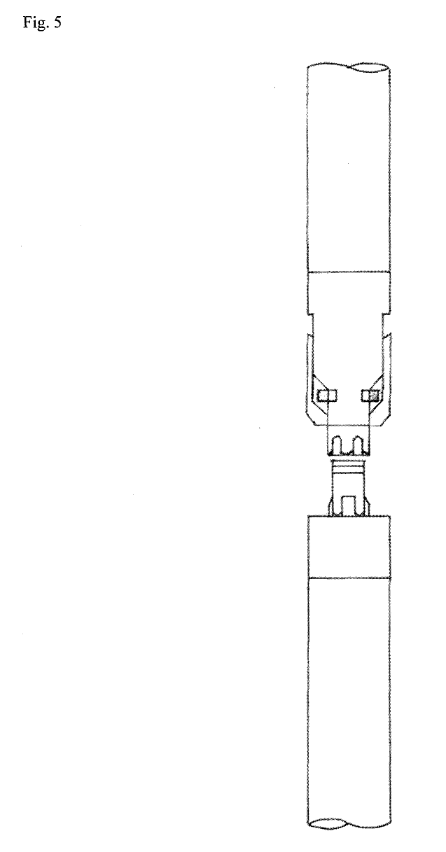

FIG. 6 is a cross sectional view of a pipe joint portraying the male and female connections connected constructed in accordance with the present invention.

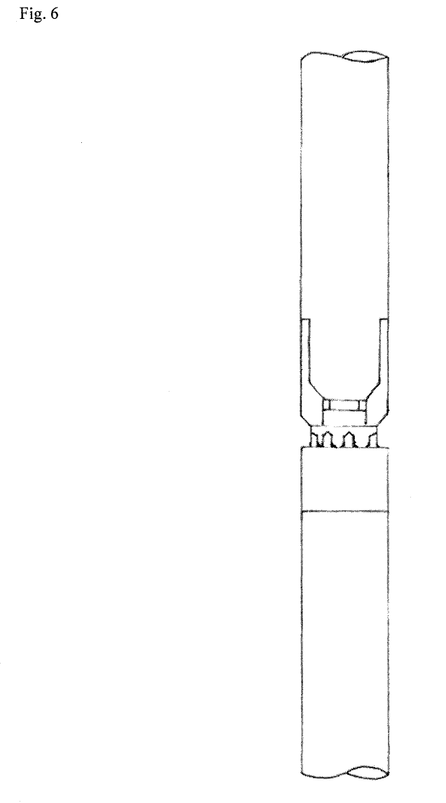

FIG. 7 is across sectional view of a coiled tubing system portraying a connector system attached to the bottom of the coiled tubing string for make up bottom hole assembly constructed in accordance with the present invention.

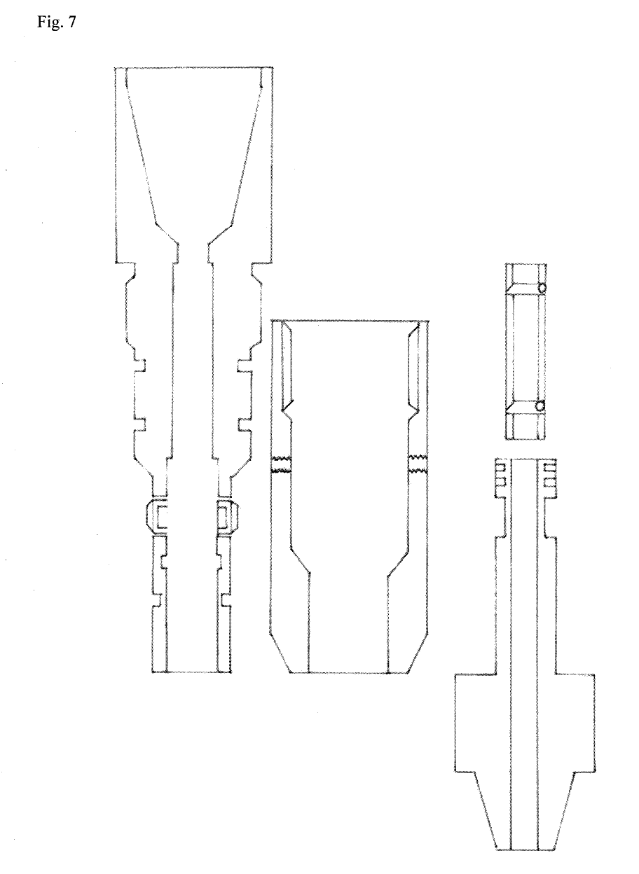

### DETAILED DESCRIPTION OF THE PREFERRED EMBODIMENTS

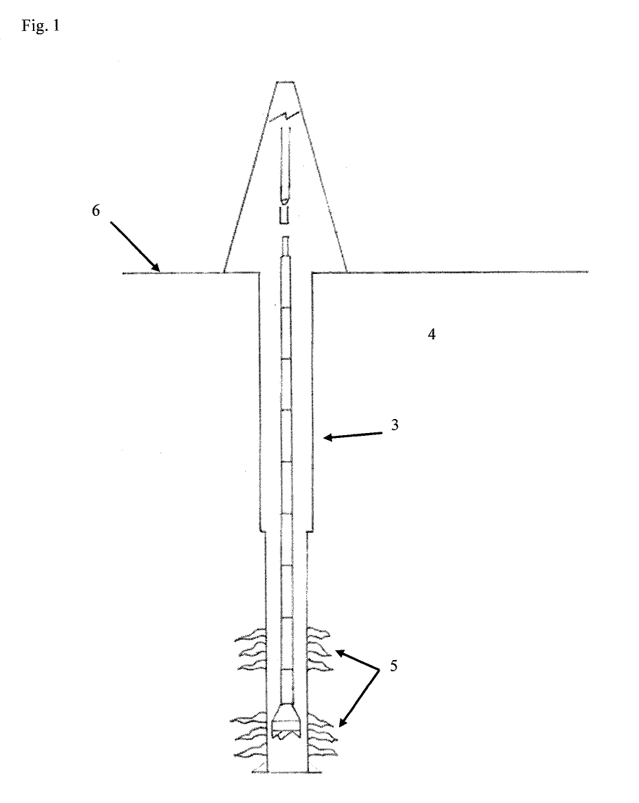

FIG. 1 illustrates an exemplary wellbore 3 which has been drilled through the earth 4 down to a hydrocarbon-bearing formation 5 from the surface 6. Perforations 7, of a type known in the art, extend through the wellbore 3 and outwardly into the formation 5 to permit hydrocarbon production fluid to flow from the formation 5 to the interior of the wellbore 3.

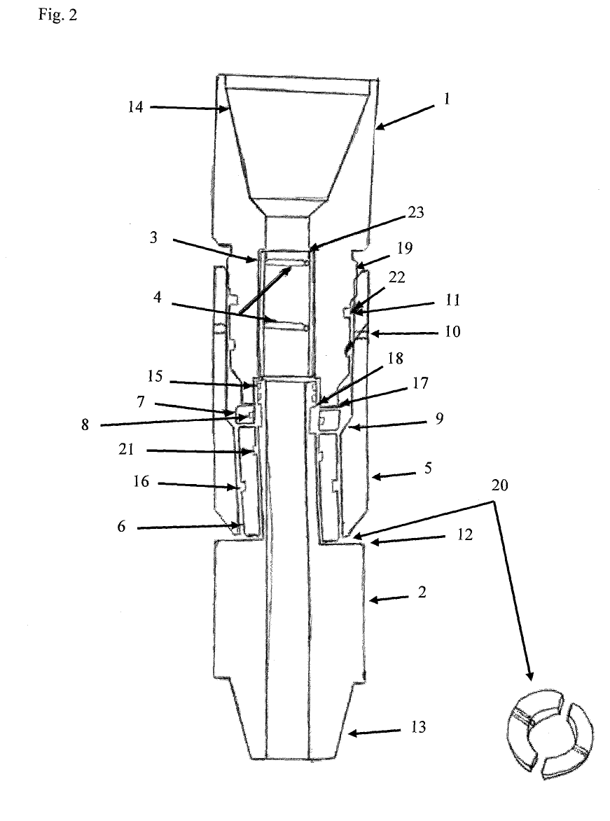

The present invention FIG. 2 provides for a way to either cross-over onto existing pipe a ‘Clutch’ joint connection that allows for make-up to individual pipe joints collet tubing pipe joints, bottom hole assemblies, tools and equipment utilizing the male and female threaded portion of the connections #13 & #14. The system can also be manufactured directly onto pipe, coiled tubing or bottom hole assemblies, tooling, etc without the need for iron rough necks, pipe wrenches, mechanical and hydraulic make-up tools, etc.

The connection #1 & #2 incorporate two sets of locking dogs #6 & #7. Locking dogs #6 are manufactured as part of the connector #1 and #2. The locking dogs #7 are manufactured as individual dogs. Locking dogs #6, allows for torque to be applied through the joint connection #1 & #2 in both clockwise and counterclockwise directions and allows for tensile and compression loading to permit both deployment and recovery the pipe, coil tubing bottom hole assembly, etc. The dogs #6 & #7 can be manufactured in multiples of two thereby permitting minimal rotation of the male #2 and female #1 pipe joints to align the connectors.

The second set of dogs #7 are the primary locking dogs designed to interlock the male #2 and female #1 connections through a set of windows #17 manufactured on the female connector. The second set of dogs #7 engage within a recessed groove #18 manufactured into the male section #2 of the Clutch connector.

The outer locking sleeve #5 is mounted upon a thread #19 on the female connector Clutch. Rotation of this sleeve clockwise will engage the four dogs #7 into the male mating groove #18 thereby locking the male #2 and female #1 Clutch connectors together. Dogs #6 will be locked to permit bi-directional torque loading during operations such as drilling. Rotation of the locking sleeve 5 engages an internal upset #9 that forces the dogs #7 into the male engagement groove #18.

Rotation of the locking sleeve #5 in the anti-clockwise direction will permit unlocking of dogs #7 thereby unlocking the music #2 and female #1 Clutch connectors for disassembly from the pipe, coiled tubing, bottom hole assembly or tools.

A spring release mechanism #8 assembled into the locking dogs #7 will apply a constant force outwardly on the locking dogs #7. When the Locking sleeve #5 is released in the anti-clockwise position the spring release mechanism #8 forces the locking dogs #7 outward away from the male locking groove #18 thereby enabling the male #2 and female #1 connectors to release.

In the event the male #2 and female #1 Clutch connectors become difficult to remove the looking sleeve #5 can be used to ‘jack’ apart the male #2 and female #1 connectors. During normal operations the locking sleeve #5 is design to stay engaged with the threads #19 when in the release position at all times.

When the locking sleeve #5 is in the locked position (clockwise), four set screws #10 are installed to prevent the locking sleeve #5 from backing off due to vibration or rotation. A separate anchor ring #20 can be placed between the male #2 and female #1 Clutch connections to ensure the Locking ring #5 cannot move in the anti-clockwise position during operations. This anchor ring #20 can be secured with cap head or set screws.

A single anchor screw can be implemented that also prevents the locking ring from any anti-rotational movement and is placed in the #6 dog section.

Elastomeric seals #11, 15 & 16 are contained on the male #2 and female #1 Clutch connectors to ensure tubing to annulus seal integrity. Wiper rings #21 & 22 are installed a top and bottom of the seals #11, 13 & 16 and locking ring #5. These prevent ingress of debris that could result in the locking sleeve #5 becoming inoperable.

When the male #2 and female #1 connectors are mated and the locking ring #5 is rotated clockwise to the set position setting the locking dogs #7 into the mating groove; 18 the system is ready to deploy into the wellbore.

Once the system is ready to perform the given operation and weight is set down on the connector the load is then transferred from the locking dogs #7 to the load Shoulder #12. This design feature prevents excessive force being applied to both the locking dogs #7 and the four windows #17. Only when load is applied to the connectors in the upward axis does the locking dogs #7 required to have any load carrying capacity.

In coiled tubing and drilling operations to prevent the return of hydrocarbons to surface via the inside diameter of the connector assembly a dual flapper cheek valve assembly #3 is installed within the connector sub #1. The dual flappers #4 are hinged and spring loaded to return to a closed position in the event hydrocarbons travel upward within the connector system. Once the flappers #4 have closed they will seal and prevent any fluid travel to surface.

The dual flapper arrangement #4 is housed in a carrier body #3. This carrier body #3 is a service item that can be removed readily by disconnecting the Clutch connection #1 & #2 by rotating the locking ring #5, releasing the locking dogs #7 and pulling the connectors apart. The dual flapper assembly #3 can now be manually retrieved from within the connector #1 and either serviced or replaced with a new dual flapper carrier arrangement #3.

What is claimed is:

1. A system locked together by means of a set of four interlocking segments providing for attachment and securing of the male and female connections.

2. An external locking sleeve, wherein said sleeve when rotated initiates a dog interlock mechanism to secure the male and female connections and ensure they are locked securely together.

3. The external locking sleeve of claim 2, wherein said sleeve when rotated anti-clockwise will de-activate the locking dogs and permit release of the male and female connectors from one another.

4. The external locking sleeve of claim 2, wherein said sleeve has a multi-start thread to ensure minimal circular rotation to provide full locking capabilities of the dogs into the male recess.

5. The external locking sleeve of claim 2, wherein said sleeve permits ease of removal of the male and female connectors in the event the system requires mechanical release, due to sticking, debris, galling, over that of manual release.

6. The external locking sleeve of claim 5, wherein said male and female connectors is removed by rotating the external locking ring anti-clockwise onto the loading shoulder to ‘jack’ apart the male and female connectors.

7. The external locking sleeve of claim 2, wherein said sleeve has an internal ramp design that engages the dog segments into the locked position through the segment windows in the female connector and interlocking into the locking groove in the male connector to secure the male and female top and bottom subs.

8. The external locking sleeve of claim 2, where said sleeve comprises an optional external ring that ensures no rotation of the locking ring is possible during operation.

9. The external locking sleeve of claim 2, wherein said male and female connectors comprises a loading and unloading shoulder for unloading of the locking dog section during milling or drilling operations when load bearing weight is applied in the downward motion.

10. A hoop spring unlocking system, comprising a locking ring that can rotate anti-clockwise to the unlocked position to push the locking dogs into unlocked position.

11. The hoop spring unlocking system of claim 10, wherein said system prevents the to locking dogs from falling into the body of the female assembly once the male has been released from the female.
